(19) United States
(12) Patent Application Publication
(10) Pub. No.: US 2025/0335601 A1
(43) Pub. Date: Oct. 30, 2025

(54) AUTOMATED SECURITY TESTING SYSTEMS USING MULTI-TIERED LANGUAGE MODELS

(71) Applicant: HITACHI, Ltd., Tokyo (JP)

(72) Inventor: Junya FUJITA, San Jose, CA (US)

(21) Appl. No.: 18/651,288

(22) Filed: Apr. 30, 2024

(51) Int. Cl. G06F 21/57

(52) U.S. Cl. CPC G06F 21/577; G06F 2221/034

(57) ABSTRACT

Cost-effective cyber security risk countermeasure systems and methods enable LLM-based automated security testing for managed cybersecurity services, without leaking sensitive information about target systems. In embodiments, this is accomplished by utilizing flexible local language models that identify and filter target system specific information when communicating with a public large language model to obtain highly accurate security testing patterns.

### BACKGROUND

### Field

The present disclosure is generally directed to security systems, and more specifically, to systems and methods for automated security testing using multi-tiered language models.

### Related Art

A significant number of Operational Technology (OT) sectors face constraints in terms of budget and manpower for conducting cybersecurity testing. A potential solution to security testing challenges is automation. Emerging technologies such as generative Artificial Intelligence (AI) and Large Language Models (LLMs) have the potential for automating various tasks across industries. Yet, LLM-based automated security testing presents its challenges. For instance, it requires detailed input information about a target system's configuration to generate effective security test patterns, which may lead to the unwanted exposure of sensitive system configuration details. To successfully implement LLM-based automated penetration testing in industries, it is thus important to address the issue of potential information leakage.

Public LLMs, such as ChatGPT (GPT-4) and Google Gemini, generate responses to user prompts with increasing degrees of accuracy as these models are constantly being updated. Public LLMs are freely available or can be accessed at a relatively low cost. In comparison, Local LMs are user-customized versions of LLMs. They need to be fine-tuned to generate environment-specific results. However, they are not automatically updated and require individual customization. Therefore, compared to public LLMs, Local LMs produce relatively low-accuracy results when responding to general prompts. LLM-based penetration testing methodologies employ a variety of tools to gather information from the actual system. The gathered information comes in diverse formats, which makes it challenging to identify sensitive information using standard pattern-matching algorithms. Existing approaches for automating penetration testing based on LLMs typically include a user-interaction function, an LLM, a tool operation unit, and a testing environment, i.e., a target system. However, these approaches oftentimes only incorporate a single LLM and do not take into account the severity of the information obtained from the target environment. As such, there is a clear need for improved systems and methods that overcome such limitations.

### SUMMARY

Some aspects of the present disclosure automatically generate security test patterns suitable for the target system while preventing the external leakage of system-related sensitive information, such as system configuration information. A cybersecurity testing system comprises a high-accuracy large language model that operates in the public cloud (public LLM) and a domain-specific language model that operates in a local environment (local LM). A scan module interacts directly with the target system to acquire data related to the configuration or security information, such as vulnerabilities of the target system. A management server interacts with the scan module to manage the configuration information and security test patterns of the target system. A finetuning module uses the data generated by the scan module to teach the local LM about the configuration and security information of the target system. The management server sends prompts to the local LM, which include instructions and command requests for security testing containing sensitive information about the system configuration. The local LM, upon receiving the prompts from the management server, converts the sensitive information of the system configuration contained in the prompts received from the management server into different words based on the information about the target system learned from the data acquired from the scan module, generates prompts for the public LLM, and obtains corresponding results from the public LLM. The management server, upon receiving a response from the public LLM, executes the reverse conversion process and generates command information that can be recognized and processed by the security module.

In some aspects of the disclosure, a method for conducting cybersecurity testing comprises scanning a target system to obtain a result including target system information; using the target system information to train a first language model to recognize sensitive information in the target system information; in a first phase of a security test, identifying a set of security test patterns for assessing the result; for a security test pattern, which may be retrieved from a database, creating a first prompt that includes the target system information and communicating the first prompt to the first language model to cause it to perform steps including: evaluating the first prompt to determine whether it includes sensitive data; in response to determining that the first prompt includes the sensitive data, performing a filtering process to generate a second prompt that includes a filtered set of commands that does not include the sensitive data; and communicating second prompt to a security test manager; in response to receiving the second prompt, communicating the second prompt to a second language model to obtain a first model response; communicating a third prompt that includes the sensitive data to the first language model to obtain a second model response that includes test commands, which may comprise a user-provided input and may be stored in the database, e.g., after being verified; and executing the test commands to initiate a security test session.

The target system information may comprise configuration information of the target system, network information of the target system, or component information of the target system. The obtained results are used to generate structured system data associated with the configuration information, which is converted into a format that is recognizable by a finetuning module that includes the first language model.

In some aspects, identifying the set of security test patterns comprises obtaining a set of test conditions provided by a user or identifying a current location of a scan module in relation to the structured system data. The test conditions and the current location may be used to determine the security test pattern. In some aspects, scanning the target system may comprise generating and communicating commands to a tool library to operate a set of tools. Some aspects further comprise, in response to determining that a command among the commands deviates from a predetermined criterion, eliminating that command.

Some aspects relate to an automated cybersecurity testing system comprising a first language model that has been trained without using sensitive information of a target system; and a second language model that has been trained using information including the sensitive information, the second language model configured to receive a first prompt including the sensitive information and return non-sensitive information, the first language model configured to generate, in response to receiving a second prompt including the non-sensitive information, a first model response.

The automated cybersecurity testing system may further comprise a scan module configured to scan a target system to obtain the sensitive information; a management server configured to generate the first prompt, the first prompt including the sensitive information and a request for security testing; and a finetuning module configured to train the second language model to learn the sensitive information, wherein the scan module may comprise a test tool library including a file system or database system to manage a security testing tool, the security testing tool including at least one of a network scanning tool, a vulnerability scanning tool, or a penetration testing tool.

In some aspects, the second language model, in response to receiving the first prompt, converts the sensitive information to non-sensitive information and communicates the non-sensitive information in the second prompt to the management server, wherein the second language model may be configured to obtain the sensitive information from at least one of the finetuning module, the scan module, or user-provided data, wherein the finetuning module may receive input data or information automatically in a machine-readable format.

Some aspects of the present disclosure can involve a system, which can involve means for performing steps comprising scanning a target system to obtain a result comprising target system information; means for using the target system information to train a first language model to recognize sensitive information in the target system information; means for identifying, in a first phase of a security test, a set of security test patterns for assessing the result; means for creating, for a security test pattern, a first prompt that comprises the target system information and communicating the first prompt to the first language model to cause it to perform steps comprising: evaluating the first prompt to determine whether it comprises sensitive data; in response to determining that the first prompt comprises the sensitive data, performing a filtering process to generate a second prompt that comprises a filtered set of commands that does not comprise the sensitive data; and communicating second prompt to a security test manager; means for communicating the second prompt to a second language model, in response to receiving the second prompt, to obtain a first model response; communicating a third prompt that comprises the sensitive data to the first language model to obtain a second model response that comprises test commands; and executing the test commands to initiate a security test session.

### BRIEF DESCRIPTION OF DRAWINGS

FIG. 1 illustrates an exemplary system for automated security testing, according to various embodiments of the present disclosure.

FIG. 2 illustrates a management server, according to various embodiments of the present disclosure.

FIG. 3 illustrates a scan module, according to various embodiments of the present disclosure.

FIG. 4 is a flowchart illustrating a process for automated security testing, in accordance with various embodiments of the present disclosure.

FIG. 5 is a flowchart illustrating a process for learning a target system structure, according to various embodiments of the present disclosure.

FIG. 6 is a dataflow diagram that illustrates an implementation of the process in FIG. 5 in a testing system, according to various embodiments of the present disclosure.

FIG. 7 is a flowchart illustrating a process for determining security test patterns, in accordance with various embodiments of the present disclosure.

FIG. 8 is a dataflow diagram that illustrates an implementation of the process in FIG. 7 in a testing system, according to various embodiments of the present disclosure.

FIG. 9 is a flowchart illustrating a process for creating prompts for security test patterns, according to various embodiments of the present disclosure.

FIG. 10 is a dataflow diagram that illustrates an implementation of the process in FIG. 9 in a testing system, according to various embodiments of the present disclosure.

FIG. 11 is a flowchart illustrating a process for creating security tests commands, in accordance with various embodiments of the present disclosure.

FIG. 12 is a dataflow diagram that illustrates an implementation of the process in FIG. 11 in a testing system, according to various embodiments of the present disclosure.

FIG. 13 is a flowchart illustrating a process for executing security tests and feedback, in accordance with various embodiments of the present disclosure.

FIG. 14 is a dataflow diagram that illustrates an implementation of the process in FIG. 13 in a testing system, according to various embodiments of the present disclosure.

FIG. 15 illustrates an example computing environment with an example computer device suitable for use in various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations. In this document, the terms “target network system” and “target system” are used interchangeably.

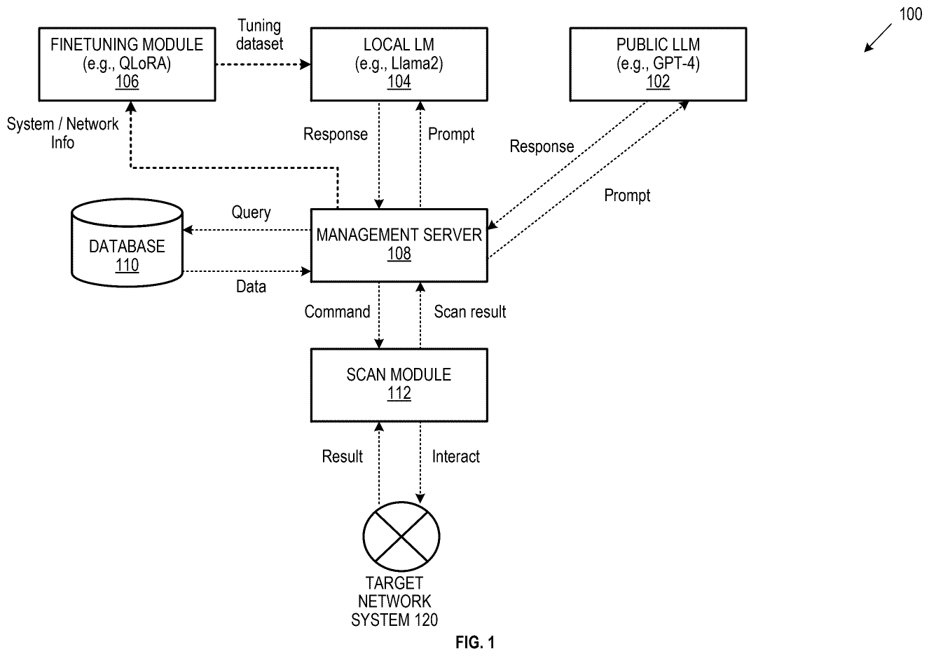

FIG. 1 illustrates an exemplary system for automated security testing, according to various embodiments of the present disclosure. System 100 comprises public LLM 102, local LM 104, finetuning module 106, management server 108, database 110, and scan module 112 that interacts with target network system 120. It is understood that scan module 112, management server 108, finetuning module 106, and local LM 104 may be integrated into a single device.

Public LLM 102 is a pre-trained language model that has a larger number of parameters than local LM 104. Public LLM 102 does not have a trained model that uses specific data or information about the to-be-tested target network system 120. Public LLM 102 is configured to analyze prompts from management server 108 and send results back to it. It is characterized by high accuracy for general prompts and cost-effectiveness, although the input might be utilized for training.

Local LM 104 is a user-customizable language model that typically has a smaller number of parameters than public LLM 102 and is trained using specific data or information about target network system 120. Local LM 104 may be implemented as (LlaMa 2, Vicuna, WizardLM, or SLM such as TinyLlaMa) can learn the target system/network architecture through finetuning module 106 and the restrictions of scan module 112. Local LM 104 can analyze prompts from management server 108, generate prompts for public LLM 102, and send results back to management server 108. Local LM 104 is configured to be trained for a specific environment and its requirement for user-owned computing resources. LLM and/or SLM implementations can operate, for example, on edge computers.

Finetuning module 106 is configured to provide training data to local LM 104 to update its language model and tune local LM 104 to learn the specific environment and configurations of a target system.

Management server 108 manages scan module 112. It can visualize system and network information, fetch data from managed scan module 112, generate an overall system/network architecture image from the fetched data and be used to manually input data, plan security test patterns, and generate prompts for local LM 104 and public LLM 102 based on the results from local LM 104.

Database 110 represents a database management system for managing and storing data and information, including system and network structure information and security test patterns (adversary database).

Scan module 112 interacts with to-be-tested target system 120. It manages test tools (tool library), stores tool execution results and edge-specific data (Data Store), executes commands using the test tools (Command Manager), and generates prompts that it sends to local LM 104 (Command Manager).

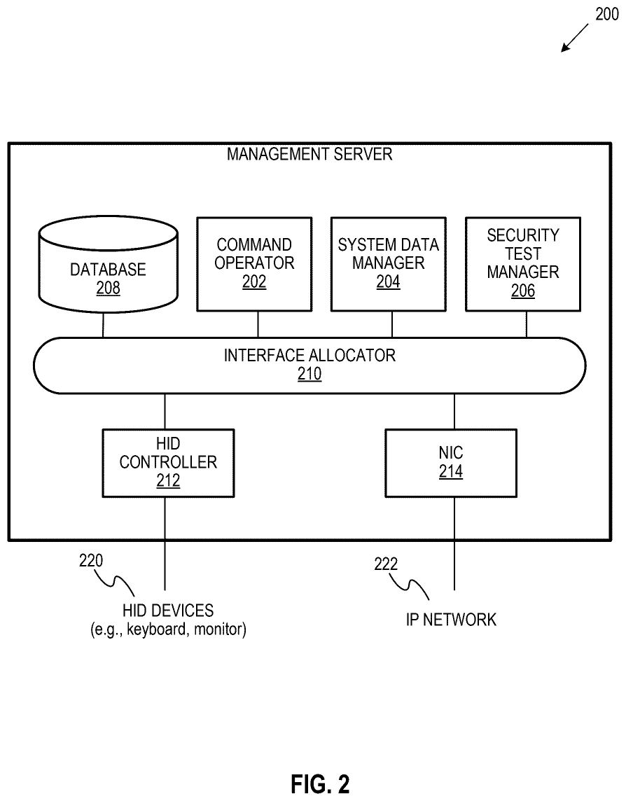

FIG. 2 illustrates a management server, according to various embodiments of the present disclosure. Management server 200 comprises command operator 202, system data manager 204, security test manager 206, database 208, interface allocator 210, HID controller database 212, network interface control (NIC) device 214, HID devices 220, and internet protocol (IP) network 222. Command operator 202 is a program that is configured to execute commands generated by security test manager 206. The commands can be run on a scan module, such as that shown in FIG. 1 (e.g., via the tool library). Command operator 202 also receives the results of the command execution from the scan module and stores them in database 208. System data manager 204 is a program that generates and manages structured system and network information data about the target system. This data is based on both input data and scanned data fetched by the scan module. As discussed in greater detail below, system data manager 204 can generate prompts for LLMs and update the structured system information based on the responses to these prompts.

Security test manager 206 is a program that generates and manages security testing plans and specific security test patterns, including tool commands. Similar to system data manager 204, security test manager 206 can generate prompts for LLMs and update the structured system information based on the responses to these prompts. Database 208 is a system for storing and managing data related to system and network structure, information about the target system, and information about security testing such as test plans and specific commands. Database 208 can be located on the same hardware device as the management server (shown in FIG. 1) or on a different device.

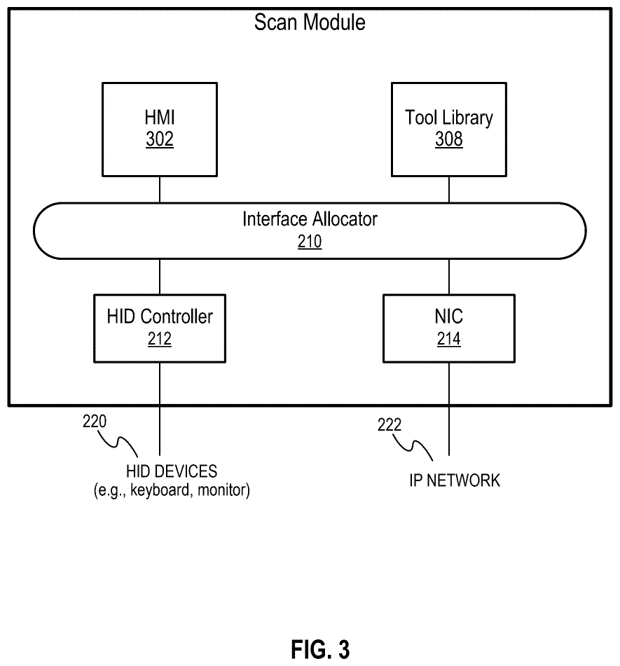

FIG. 3 illustrates a scan module, according to various embodiments of the present disclosure. Scan module 300 comprises Human Machine Interface (HMI) 302, HID controller database 212, NIC device 214, tool library 308, and interface allocator/pipe 210.

HMI 302 comprises features such as a Web browser, GUI including X Window System, etc., and provides a user-friendly interface for users to interact with a management server such as that depicted in FIG. 1. HID controller database 212 may comprise software that controls physical HID devices 220, to facilitate user interaction with the system. NIC device 214 is used to connect the system to TCP/IP network 222 to enable network communication for the system. Tool library 308 is a file system or database system that manages security testing tools such as network scanning tools (e.g., nmap), vulnerability scanning tools (e.g., GVM, NESSUS), penetration testing tools (e.g., Metasploit, Empire), and runtime environments to run security testing tools (e.g., Python, C libraries, Powershell). Interface allocator/pipe 210 allocates and manages network sockets or serial interfaces to each program operating on the device. Interface allocator/pipe 210 may be implemented as a function of an operating system (e.g., MS Windows, Linux).

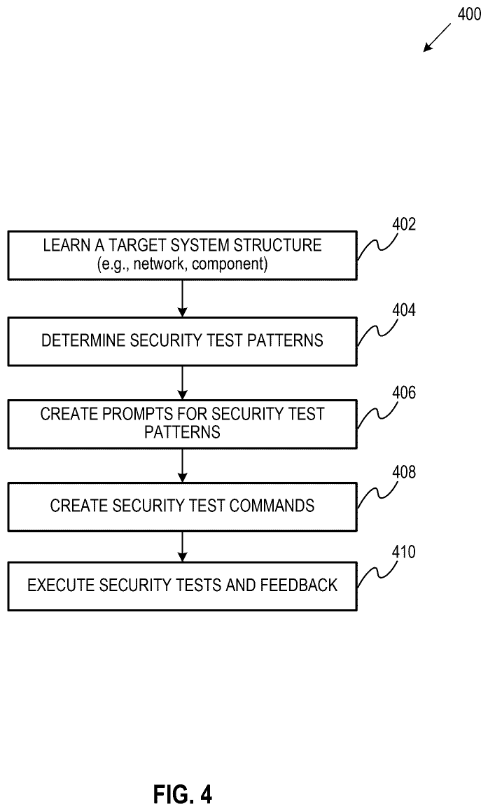

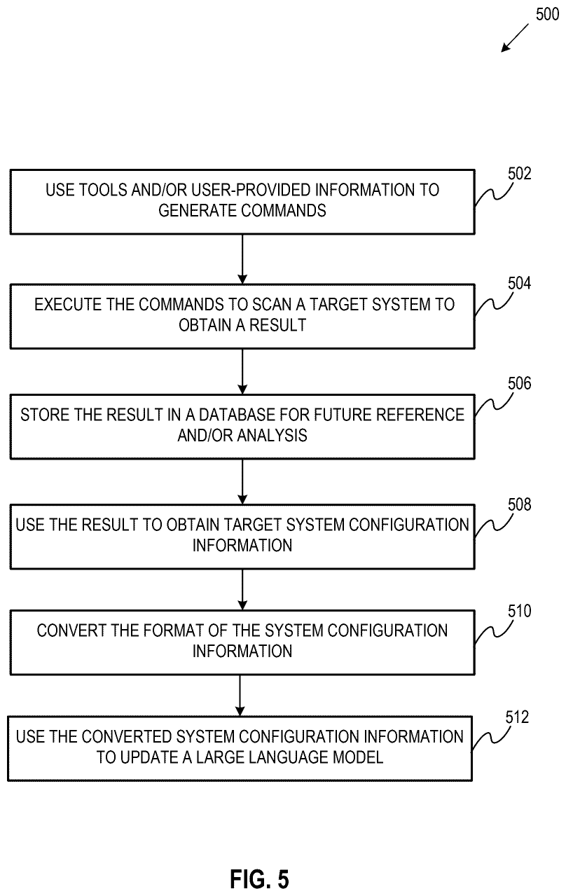

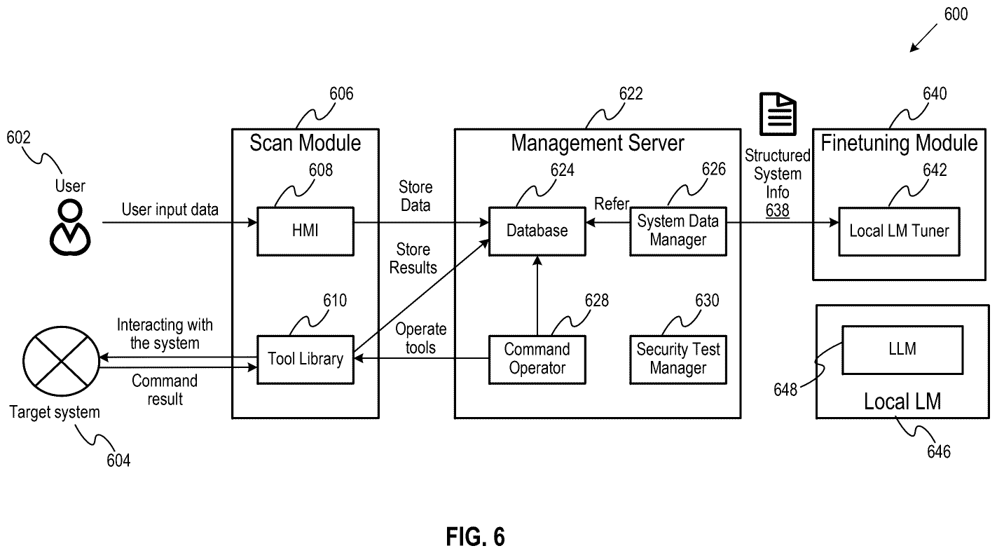

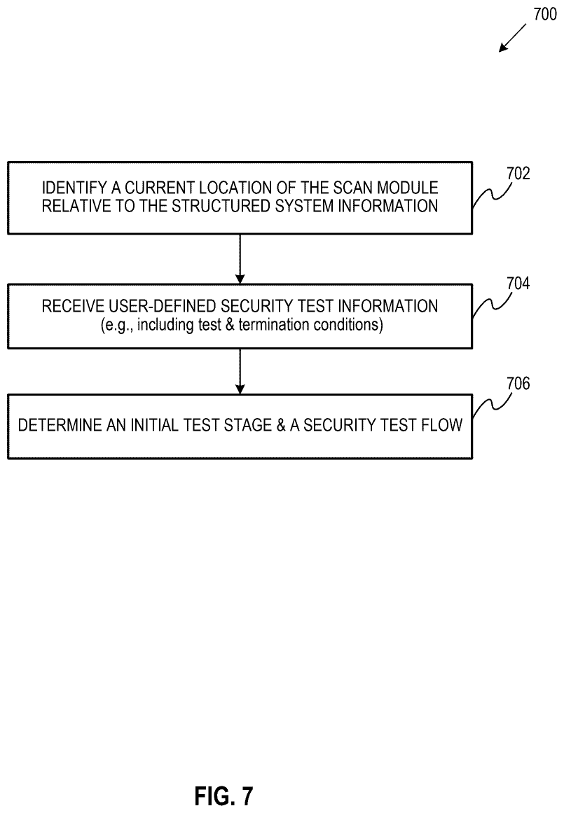

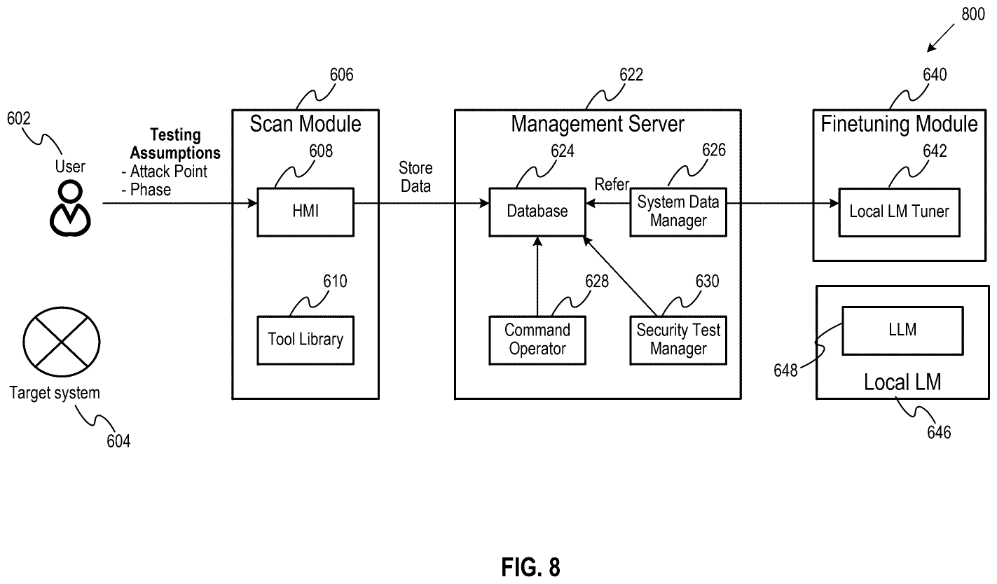

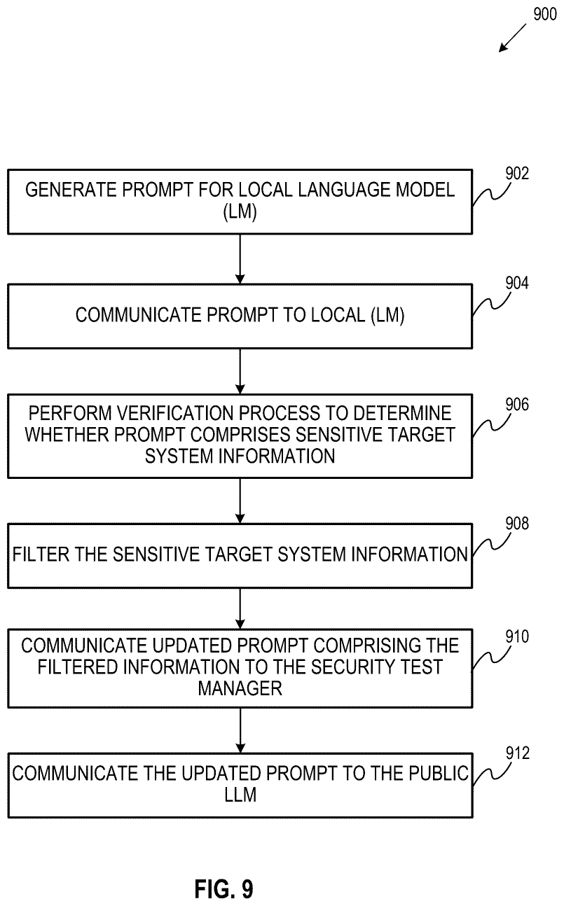

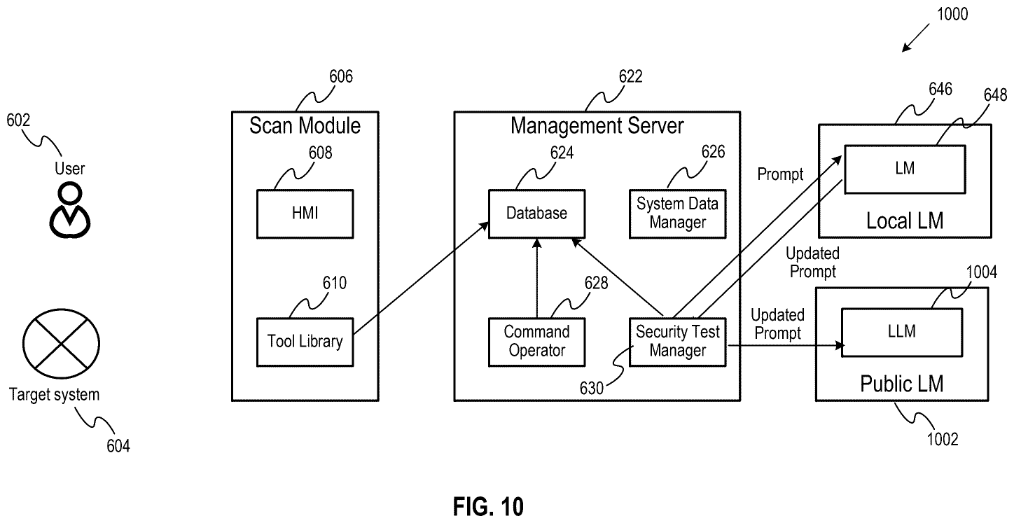

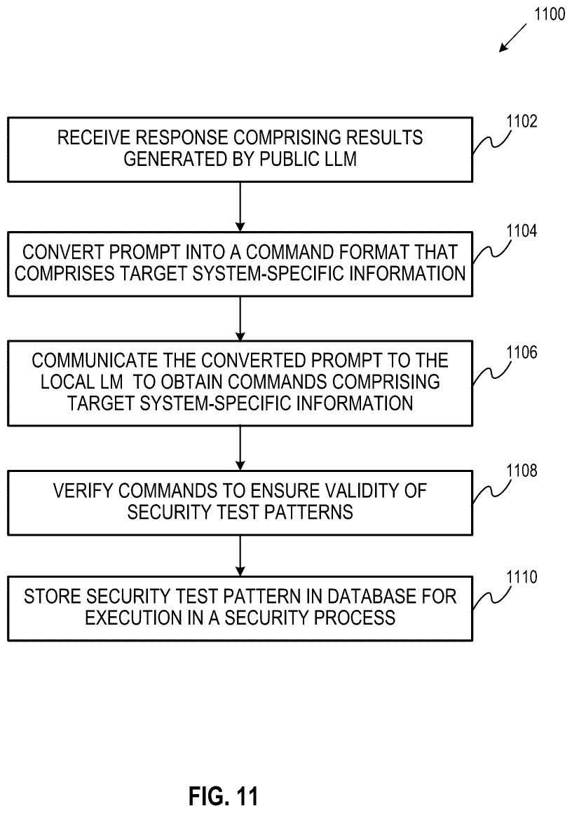

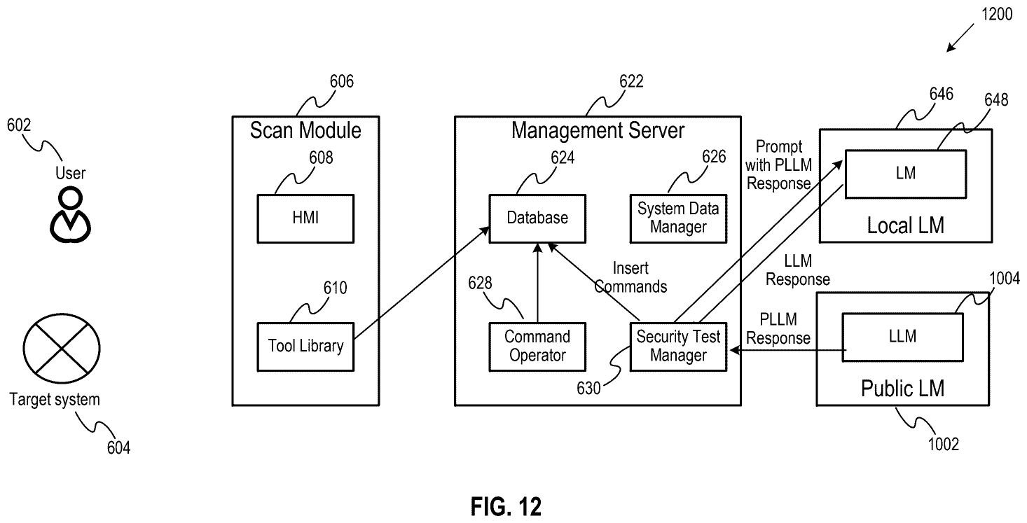

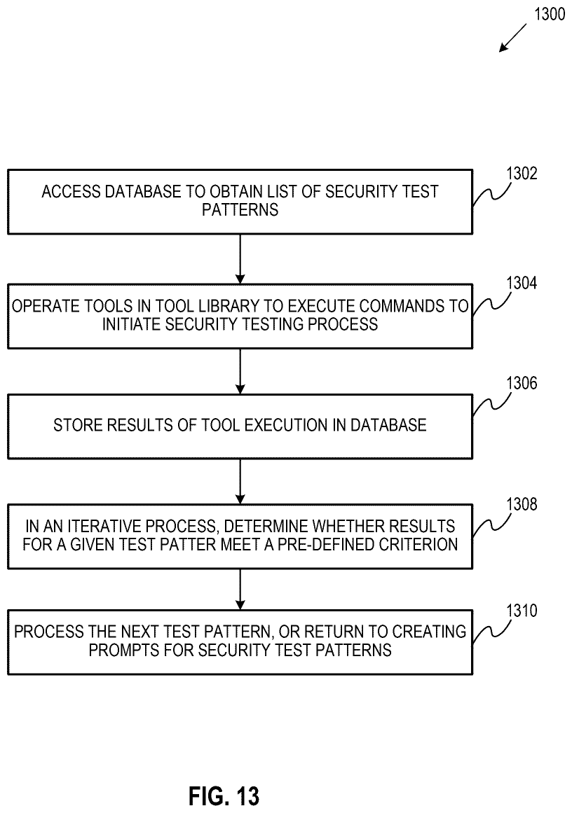

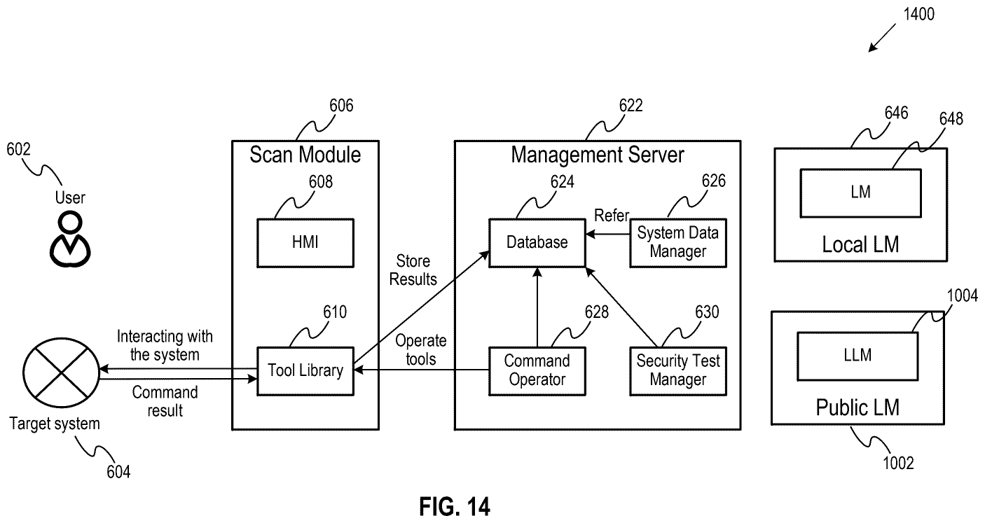

FIG. 4 is a flowchart illustrating a process for automated security testing, in accordance with various embodiments of the present disclosure. Process 400 starts at step 402, when a target system structure is learned, as will be further discussed in greater detail with reference to FIG. 5 and FIG. 6. At step 404, security test patterns are determined, as discussed in greater detail with reference to FIG. 7 and FIG. 8. At step 406, prompts for security test patterns are created, as further discussed in greater detail with reference to FIG. 9 and FIG. 10. At step 408, security test commands are created, as further discussed in greater detail with reference to FIG. 11 and FIG. 12. Finally, at step 410, security tests and feedback are executed, as further discussed in greater detail with reference to FIG. 13 and FIG. 14. One skilled in the art shall recognize that: (1) certain steps may optionally be performed; (2) steps may not be limited to the specific order set forth herein; (3) certain steps may be performed in different orders; and (4) certain steps may be done concurrently.

FIG. 5 is a flowchart illustrating a process for learning a target system structure, according to various embodiments of the present disclosure. Process 500 may start at step 502, when a set of commands are generated, e.g., by a command operator that uses a pre-built tool or an LLM. The command operator may use tools that are available in the tool library. In addition, the command operator may incorporate user knowledge or expertise and/or additional information about the system configuration into the security testing process, e.g., via a Human-Machine Interface (HMI). At step 504, the generated set of commands is executed to perform one or more scans on a target system to obtain scan results. At step 506, the scan results may be stored in a database, e.g., for future reference and analysis. At step 508, a system data manager may use the results to generate structured system information related to the system configuration, which represents a comprehensive overview of the target system's configuration. At step 510, the structured system information is converted into a format that is easily recognizable by a finetuning module. At step 512, the converted information is used to update a large language model (LLM) of a local LM to ensure that the LLM uses the latest system configuration information to generate accurate and relevant security test patterns.

FIG. 6 is a dataflow diagram that illustrates an implementation of the process in FIG. 5 in a testing system, according to various embodiments of the present disclosure. Testing system 600 comprises user 602, target system 604, scan module 606, management server 622, finetuning model 640, and local LM 646. As depicted, scan module 606 comprises HMI 608, and tool library 610. Management server 622 comprises database 624, system data manager 626, command operator 628, and security test manager 630. Finetuning module 640 comprises local LM tuner 642, which accesses local LM 646 that comprises a local LLM 648.

In operation, command operator 628 uses a number of pre-built tools (or an LLM) in tool library 610 and/or user input data that may be stored, via HMI 608, in database 624 to generate commands. When executed by scan module 606, these commands perform scans on target system 604, which may be stored in database 624. System data manager 626 uses these results to generate structured system information 638 that is related to the system configuration of target system 604. Finetuning module 640 converts structured system information 638 into a format that is recognizable by local LM tuner 642. Then, the converted information is used to update LLM 648 of local LM 646.

FIG. 7 is a flowchart illustrating a process for determining security test patterns, in accordance with various embodiments of the present disclosure. Process 700 may start at step 702, when, based on the collected information, the current location of the scan module relative to the structured system information is identified. At step 704, user-defined security test conditions, such as test and termination conditions, are received via the HMI. At step 706, based on the current location of the scan module and the input information, the security test manager determines the security test flow and/or security test pattern and the initial test stage. FIG. 8 is a dataflow diagram that illustrates an implementation of the process in FIG. 7 in a testing system, according to various embodiments of the present disclosure. Same numerals as in FIG. 6 denote similar elements. For purposes of brevity, a description or their function is not repeated here.

FIG. 9 is a flowchart illustrating a process for creating prompts for security test patterns, according to various embodiments of the present disclosure. Once the initial test stage has been determined, the security test manager decides on the to-be-executed test pattern at the relevant stage. In making this decision, the security test manager, at step 902, generates a prompt to inquire with the local LLM about the commands that should be executed based on the current stage, current location, and structured system information. At step 904, the security test manager communicates the generated prompt to the local LM. At step 906, upon receiving the prompt, the local LM interprets its content and determines whether the prompt contains sensitive information regarding the target system. At step 908, if the verification process reveals that the prompt does contain such sensitive information, the local LM performs a filtering process on the relevant information. At step 910, the local LM then responds to the security test manager by communicating an updated prompt that comprises the filtered information. At step 912, the updated prompt, now free of sensitive information, is sent to the public LLM to ensure that the public LLM receives and processes only non-sensitive information that is safe for public access. FIG. 10 is a dataflow diagram that illustrates an implementation of the process in FIG. 9 in a testing system, according to various embodiments of the present disclosure.

Testing system 100 in FIG. 10 comprises user 602, target system 604, scan module 606, management server 622, local LM 646 having language model 648, and public LM 1002 having LLM 1004. Similar to FIG. 6, scan module 606 comprises HMI 608, and tool library 610. Management server 622 comprises database 624, system data manager 626, command operator 628, and security test manager 630.

FIG. 11 is a flowchart illustrating a process for creating security tests commands, in accordance with various embodiments of the present disclosure. Process 1100 may start at step 1102, when the security test manager receives from the public LLM the prompt that contains the response results generated in the flowchart in FIG. 9. At step 1104, the prompt is converted into a command format that comprises information specific to the target system to ensure that the commands are tailored to the specific requirements and characteristics of the target system. At step 1106, the security test manager communicates the converted prompt to the local LM to obtain a result that comprises the tailored commands. At step 1108, in response to receiving the commands from the local LLM, the security test manager verifies the commands. If any command is found to deviate from a prescribed criterion, it is eliminated to ensure that only valid and relevant commands are executed during the security testing process. At step 1110, the commands are stored in a database as security test patterns that should be executed accessed and executed during a security testing process. FIG. 12 is a dataflow diagram that illustrates an implementation of the process in FIG. 11 in a testing system, according to various embodiments of the present disclosure.

FIG. 13 is a flowchart illustrating a process for executing security tests and feedback, in accordance with various embodiments of the present disclosure. Process 1300 may start at step 1302, when the command operator accesses the database to obtain a list of security test patterns to initiate a security testing session. At step 1304, based on the test patterns, the command operator operates the suite of tools in the tool library to execute the commands, which are configured to probe the target system for potential vulnerabilities. At step 1306, the results of the tool execution are stored in the database. At step 1308, the security test manager determines, e.g., in an iterative process and based on the results of the tool execution, whether the goals for the current stage have been achieved and assesses any additional information obtained about the target system. At step 1310, if the goals for the current stage have been achieved, the next test pattern is determined based on the security test flow information. If not, a different test pattern is generated, and the process returns to step 406 in FIG. 4. FIG. 14 is a dataflow diagram that illustrates an implementation of the process in FIG. 13 in a testing system, according to various embodiments of the present disclosure.

Upon completing the process of executing security tests (see, e.g., step 410 in FIG. 4), the security test results are generated and stored in the database within the management server. It is noted that the results may be stored in raw data format or be partially extracted from the original results from the scan module.

Any headings used herein are for organizational purposes only and shall not be used to limit the scope of the present disclosure.

### Structured System Information

As used herein, structured system information may comprise information about a target test system architecture, configurations, and security vulnerabilities. This includes information describing the target system's components and attributions, such as a list of assets, a list of logical networks, and a list of physical places where each asset is deployed. A local LM as disclosed herein may learn the system and network structure from this system structure information.

Each asset information entry may comprise a unique asset name and attribution information about the characteristics of that asset, information about the logical network to which it is connected, information about the physical location where it is installed, and security vulnerability information that has been identified. Vulnerability information may comprise vulnerabilities associated inherent to both hardware or software, as well as vulnerabilities that are identified during the security testing.

Structured system information may further comprise information that defines the characteristics of each logical network and physical place. Each logical network entry may have a unique name and attribution information about the logical network, such as media types. Each physical place entry may have a unique name and attribution information about the physical place, such as security level.

Structured system information may be defined in structured and machine-readable formats such as JSON, XML, and relational databases. The information may be managed in a database that the management server is configured to interact with. A finetuning module for the local LLM as described herein may read structured system information, e.g., to train a local LLM. The local LLM can recognize what assets are in the target system, the network structure, and the physical structure.

Table 1 illustrates an example of structured system information. In this example, the information is described in JSON format. As a person of skill in the art will appreciate, any suitable machine-readable format, such as CSV or XML may be employed. The underlined text in Table 1 identifies actual or potential sensitive system-specific information that should be converted to non-sensitive information by the local LM.

```
TABLE 1
{
  “title”: “The Silicon Valley Factory Automation system
  structure define file”,
  “overview”: “This is a file that defines the system configuration.”,
  “assets”: [
    {
      “assetName”: “Line-Kitting Server”,
      “description”: “This is a server machine which processes.”,
      “platformHardware”: “HOST”,
      “platformSoftware”: “WINDOWS 10 Professionals Version
      10.0.22621.xxxx”,
      “connectedNetworks”: [“ProductionLAN1” ],
      “deployPoint”: “Factory Server Room - Rack X”,
      “vulnerabilities”: [“CVE-20XX-XXXX”, “CVE-20XX-YYYY”,
      “CVE-
      20XX-ZZZZ”]
    },
    ...
  ].
  “logicalNetworks”: [
    {
      “networkName”: “ProductionLAN1”,
      “description”: “This is a local area network for the production
      devices.”,
      “networkType”: “Ethernet”,
      “nodes”: {Line-Kitting Server” : “192.168.XX.XX”, “Gateway”:
      “192.168.XX.YY”, ...},
    },
    ...
  ].
  ...
  “physicalPlacess”: [
    {
      “placeName”: “Factory Server Room - Rack X”,
      “description”: “The rack X in the factory sever room”,
      “securityLevel”: “Low”,
    },
  ]
}
```

### Sensitive Information

As used herein, sensitive information refers to details about a target system that its owner does not wish to expose externally. Examples of such information comprise: names of assets and any other identifiers; network structure; physical structure; system user information; credentials; elements of assets; information on custom applications that are working on internal networks, such as source codes; user-provided information; and security vulnerabilities in the target system environment and any assets.

In embodiments, specific information may be concealed. A management server generates prompts based on security test plans and the structured system information about a target system. These raw prompts contain information about the target system defined in the structured system information as shown in Table 2.

TABLE 2

Check the prompts sentence if it contains information
about the target system that you learned via the input
structured JSON file. Pick up specific words and modify
them to more generic words if there are.-
“The current attack phase is a scanning network ports of
‘Line-Kitting Server’ whose IP address is ‘192.168.XX.XX’
to find vulnerabilities and possible attack surfaces. Can
you generate a scan command using nmap? Please answer
JSON format.”
Please generate JSON format like {“prompt”: “(The modified
prompt sentence)”}

A local LM may identify and suggest specific words, generating modified prompts. A possible result example is shown in Table 3.

TABLE 3

```
Yes, I found the specific words - “Line-Kitting Server” and
“192.168.XX.XX”. Let's change those words to “ServerX”
and “1.2.3.4”
{
  “prompt”: [“The current attack phase is scanning
  network ports of ‘ServerX’ whose IP address is
‘1.2.3.4’ to find vulnerabilities and possible attack
surfaces. Can you generate a scan command using nmap?
Please answer JSON format.”]
}
```

A management server may parse the response from the local LM and transfer the modified prompt to the public LLM, as illustrated in Table 4.

TABLE 4

(Management server prompt) The current attack phase is
scanning network ports of ‘ServerX’ whose IP address is
‘1.2.3.4’ to find vulnerabilities and possible attack
surfaces. Can you generate a scan command using nmap?
Please answer JSON format
(Public LLM response)
{“command”: “nmap”, “arguments”: {“target”: “1.2.3.4”,
“options”: [“-sV”, “-p 1-65535”, “-T4”, “--open”],
“description”: “Scan all ports to find vulnerabilities
and possible attack surfaces on ServerX with IP 1.2.3.4.”}}

Once the management server receives the response from the public LLM, the management server generates a prompt to the local LM to obtain commands applicable to the target system. This allows for obtaining more accurate security test commands from the public LLM, while hiding information specific to the target system. An example is shown in Table 5.

TABLE 5

| (Management server prompt) Based on the word change rule | |
|---|---|
| you applied, please modify the following command to | |
| include the original system-specific information. | |
| {“command”: “nmap”, “arguments”: {“target”: 1.2.3.4”, | |
| “options”: [“-sV”, “-p 1-65535”, “-T4”, “--open”], | |
| “description”: “Scan all ports to find vulnerabilities and | |
| possible attack surfaces on ServerX with IP 1.2.3.4.”}} | |
| (Local LM response) | |
| Sure, here is the result. | |
| JSON: | |
| { | |
| “command”: “nmap”, | |
| “arguments”: { | |
| “target”: “192.168.XX.XX”, | |
| “options”: [ | |
| | “-sV”, |
| | “-p 1-65535”, |
| | “-T4”, |
| | “--open” |
| ], | |
| “description”: | “Scan all ports to find |
| | vulnerabilities and possible attack |
| | surfaces on Line-Kitting Server |
| | with IP 192.168.XX.XX.” |

```
    }
  }
```

It is noted that although relatively simple pattern-matching algorithms may be used to extract sensitive information, language models typically offer greater flexibility as that are more effective in determining sensitive information from input sources and can extract potentially sensitive information. An example for a local LM is shown in Table 6.

TABLE 6

```
(Management server prompt) Please up possible sensitive
information from the input list in JSON. Like - {
“sensitiveInfo”: [“A”, “B”: “C”, “D”, ...]}
(Local LM response)
Based on the structure and content of the provided JSON
snippet, here are possible sensitive pieces of information
that could be considered for extraction:
JSON:
  {
  “sensitiveInfo”: [
    “Line-Kitting”,
    “Line-Kitting Server”,
    “WINDOWS 10 Professionals Version 10.0.22621.xxxx”,
    “ProductionLAN1”,
    “CVE-20XX-XXXX”,
    “CVE-20XX-YYYY”,
    “CVE-20XX-ZZZZ”,
    “192.168.XX.XX”,
    “192.168.XX.YY”,
    “Factory Server Room - Rack X”
  ]
  }
```

In embodiments, to create detailed security testing patterns for specific components such as “WINDOWS 10 Professionals Version 10.0.22621.xxxx” as a result of a scan of the target system, a prompt may be created to test the specific attributions. The information “WINDOWS 10 Professionals Version 10.0.22621.xxxx” itself is not sensitive unless any target system or owner information is disclosed. Therefore, specific security testing patterns may be fetched from a public LLM without sensitive information being disclosed. The image is shown in Table 7.

TABLE 7
Management Server → Local LM

```
(Management server prompt) Please up possible sensitive
information from the input list in JSON. Like - {
“sensitiveInfo”: [“A”, “B”, “C”, “D”, ...]}
(Local LM response) Based on the structure and content
of the provided JSON snippet, here are possible
sensitive pieces of information that could be
considered for extraction:
JSON:
  {
  “sensitiveInfo”: [
    “Line-Kitting”,
    “Line-Kitting Server”,
    “WINDOWS 10 Professionals Version 10.0.22621.xxxx”,
    “ProductionLAN1”,
    “CVE-20XX-XXXX”,
    “CVE-20XX-YYYY”,
    “CVE-20XX-ZZZZ”,
    “192.168.XX.XX”,
    “192.168.XX.YY”,
    “Factory Server Room - Rack X”
  ]
  }
```

TABLE 8
Management Server → Public LM

```
(Management server prompt) Please generate test
commands on the “WINDOWS 10 Professionals
Version 10.0.22621.xxxx” to test if there are any
vulnerabilities that lead to privilege escalation using
PowerSploit.
(Public LLM response) PowerSploit is a collection
of Microsoft PowerShell modules that can be used for
penetration testing and security assessments. It is
important to note that PowerSploit should only be used in
a legal and authorized manner, and typically within the
context of a penetration test where you have explicit
permission to perform such actions.
To test for privilege escalation vulnerabilities on
“WINDOWS 10 Professionals Version 10.0.22621.xxxx”,
you can use PowerSploit's Privesc module which contains
multiple scripts to assess and exploit vulnerable
settings an configurations.
Here is an example of how to use PowerSploit to check
for common privilege escalation vectors:
Powershell:
  # Import the PowerSploit Module
  Import-Module .\PowerSploit\Privesc\Privesc.psd1
  # Find vulnerable service permissions
  Get-ServiceUnquoted -Verbose
  # Find services with unquoted paths that can be exploited
  Get-ServiceEXEPerms -Verbose
  ...
```

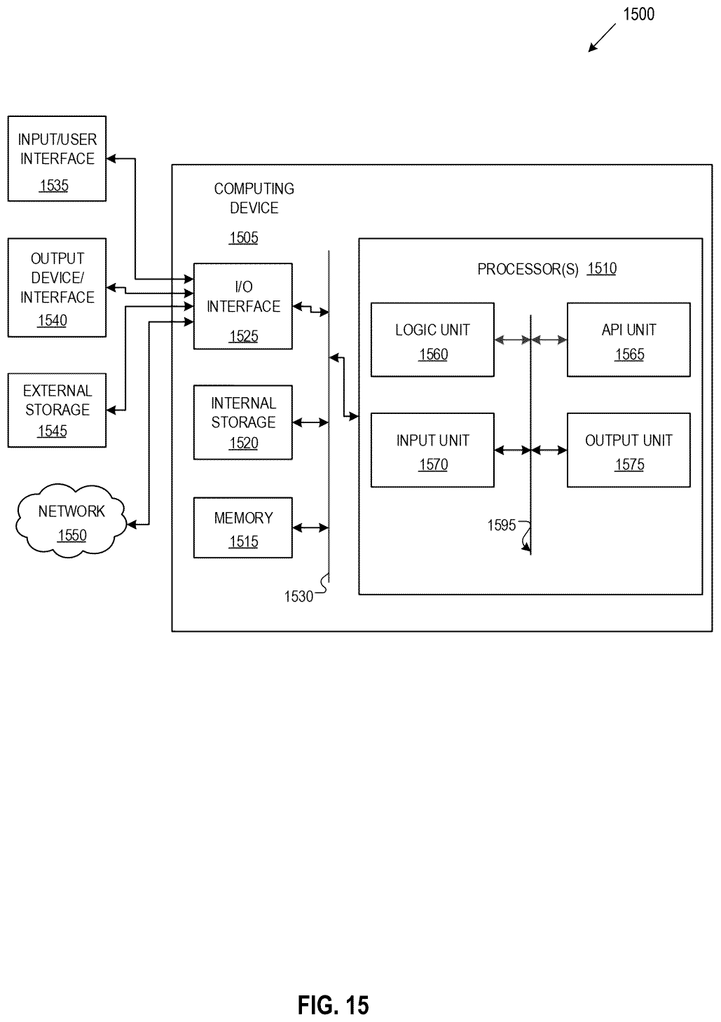

FIG. 15 illustrates an example computing environment with an example computer device suitable for use in various embodiments of the present disclosure. Computer device 1505 in computing environment 1500 can include one or more processing units, cores, or processors 1510, memory 1515 (e.g., RAM, ROM, and/or the like), internal storage 1520 (e.g., magnetic, optical, solid-state storage, and/or organic), and/or I/O interface 1525, any of which can be coupled on a communication mechanism or bus 1530 for communicating information or embedded in the computer device 1505. I/O interface 1525 is also configured to receive images from cameras or provide images to projectors or displays, depending on the desired implementation.

Computer device 1505 can be communicatively coupled to input/user interface 1535 and output device/interface 1540. Either one or both of input/user interface 1535 and output device/interface 1540 can be a wired or wireless interface and can be detachable. Input/user interface 1535 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1540 may include a display, television, monitor, printer, speaker, braille, or the like. In some example implementations, input/user interface 1535 and output device/interface 1540 can be embedded with or physically coupled to the computer device 1505. In other example implementations, other computer devices may function as or provide the functions of input/user interface 1535 and output device/interface 1540 for a computer device 1505.

Examples of computer device 1505 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1505 can be communicatively coupled (e.g., via I/O interface 1525) to external storage 1545 and network 1550 for communicating with any number of networked components, devices, and systems, including one or more computer devices of the same or different configurations. Computer device 1505 or any connected computer device can be functioning as, providing services of, or referred to as a server, client, thin server, general machine, special-purpose machine, or another label.

I/O interface 1525 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1500. Network 1550 can be any network or combination of networks (e.g., the Internet, local area network, wide area network, a telephonic network, a cellular network, a satellite network, and the like).

Computer device 1505 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1505 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1510 can execute under any operating system (OS) (not shown), in a native or virtual environment. One or more applications can be deployed that include logic unit 1560, application programming interface (API) unit 1565, input unit 1570, output unit 1575, and inter-unit communication mechanism 1595 for the different units to communicate with each other, with the OS, and with other applications (not shown). The described units and elements can be varied in design, function, configuration, or implementation and are not limited to the descriptions provided. Processor(s) 1510 can be in the form of hardware processors such as central processing units (CPUs) or a combination of hardware and software units.

In some example implementations, when information or an execution instruction is received by API unit 1565, it may be communicated to one or more other units (e.g., logic unit 1560, input unit 1570, output unit 1575). In some instances, logic unit 1560 may be configured to control the information flow among the units and direct the services provided by API unit 1565, input unit 1570, and output unit 1575, in some example implementations described above. For example, the flow of one or more processes or implementations may be controlled by logic unit 1560 alone or in conjunction with API unit 1565. The input unit 1570 may be configured to obtain input for the calculations described in the example implementations, and the output unit 1575 may be configured to provide output based on the calculations described in example implementations.

Processor(s) 1510 can be configured to execute a method or computer instructions which can involve, scanning a target system, as illustrated in FIG. 1, to obtain a result including target system information; using the target system information to train a first language model to recognize sensitive information in the target system information; in a first phase of a security test, identifying a set of security test patterns for assessing the result; for a security test pattern, creating a first prompt that includes the target system information and communicating the first prompt to the first language model, as illustrated, e.g., in FIGS. 1 and 10.

This causes first language model to perform steps comprising: evaluating the first prompt to determine whether it includes sensitive data; in response to determining that the first prompt includes the sensitive data, performing a filtering process to generate a second prompt that includes a filtered set of commands that does not include the sensitive data; and communicating second or updated prompt to a security test manager, as illustrated, e.g., in FIGS. 1 and 10.

Processor(s) 1510 can be configured to execute a method or computer instructions which can involve, in response to receiving the second prompt, communicating the second prompt to a second language model to obtain a first model response, as illustrated, e.g., in FIGS. 1 and 10; communicating a third prompt that includes the sensitive data to the first language model to obtain a second model response that includes test commands, as illustrated, e.g., in FIGS. 1 and 10.

Processor(s) 1510 can be configured to execute a method or computer instructions which can involve, executing the test commands to initiate a security test session, as illustrated, e.g., in FIGS. 1 and 14.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for conducting cybersecurity testing, the method comprising:
scanning a target system to obtain a result comprising target system information;
using the target system information to train a first language model to recognize sensitive information in the target system information;
in a first phase of a security test, identifying a set of security test patterns for assessing the result;
for a security test pattern, creating a first prompt that comprises the target system information and communicating the first prompt to the first language model to cause it to perform steps comprising:
evaluating the first prompt to determine whether it comprises sensitive data;
in response to determining that the first prompt comprises the sensitive data, performing a filtering process to generate a second prompt that comprises a filtered set of commands that does not comprise the sensitive data; and
communicating second prompt to a security test manager;
in response to receiving the second prompt, communicating the second prompt to a second language model to obtain a first model response;
communicating a third prompt that comprises the sensitive data to the first language model to obtain a second model response that comprises test commands; and
executing the test commands to initiate a security test session.

2. The method according to claim 1, wherein the target system information comprises at least one of a configuration information of the target system, network information of the target system, or component information of the target system.

3. The method according to claim 2, further comprising using the result to generate structured system data associated with the configuration information.

4. The method according to claim 3, further comprising converting the structured system data into a format that is recognizable by a finetuning module that comprises the first language model.

5. The method according to claim 3, wherein identifying the set of security test patterns further comprises obtaining a set of test conditions provided by a user.

6. The method according to claim 5, wherein identifying the set of security test patterns further comprises identifying a current location of a scan module in relation to the structured system data.

7. The method according to claim 6, further comprising using the set of test conditions and the current location to determine the security test pattern.

8. The method according to claim 6, wherein at least some of the commands comprise a user-provided input.

9. The method according to claim 1, wherein scanning the target system comprises generating and communicating commands to a tool library to operate a set of tools.

10. The method according to claim 1, further comprising, in response to determining that a command among the commands deviates from a predetermined criterion, eliminating that command.

11. The method according to claim 1, further comprising verifying the test commands and storing them in a database.

12. The method according to claim 11, wherein the set of test patterns is retrieved from the database.

13. An automated cybersecurity testing system comprising:
a first language model that has been trained without using sensitive information of a target system; and
a second language model that has been trained using information comprising the sensitive information, the second language model configured to receive a first prompt comprising the sensitive information and return non-sensitive information, the first language model configured to generate, in response to receiving a second prompt comprising the non-sensitive information, a first model response.

14. The system of claim 13, further comprising:
a scan module configured to scan a target system to obtain the sensitive information;
a management server configured to generate the first prompt, the first prompt comprising the sensitive information and a request for security testing; and
a finetuning module configured to train the second language model to learn the sensitive information.

15. The system of claim 14, wherein the second language model, in response to receiving the first prompt, converts the sensitive information to non-sensitive information and communicates the non-sensitive information in the second prompt to the management server.

16. The system of claim 14, wherein second language model is configured to obtain the sensitive information from at least one of the finetuning module, the scan module, or user-provided data.

17. The system of claim 14, wherein the finetuning module is configured to receive input data or information automatically in a machine-readable format.

18. The system of claim 14, further comprising a database configured to store information about the target system, the information comprising at least one of network information, or security testing information, or test pattern results.

19. The system of claim 14, wherein the scan module comprises a test tool library comprising a file system or database system to manage a security testing tool, the security testing tool comprising at least one of a network scanning tool, a vulnerability scanning tool, or a penetration testing tool.

20. The system of claim 13, wherein the first language model comprises a greater number of parameters than the second language model.
